(19) United States
(12) Patent Application Publication
(10) Pub. No.: US 2018/0210882 A1
(43) Pub. Date: Jul. 26, 2018

(54) Computer System for Managing Digital Media of an Organization

(71) Applicant: Jalea Technology, Inc., Boucherville (CA)

(72) Inventor: Michael Sheasby, Montreal (CA)

(21) Appl. No.: 15/877,773

(22) Filed: Jan. 23, 2018

Related U.S. Application Data
(60) Provisional application No. 62/450,068, filed on Jan. 24, 2017.

(51) Int. Cl. G06F 17/30

(52) U.S. Cl. CPC G06F 17/3005; G06F 17/30256; G06F 17/30294

(57) ABSTRACT

A computer system provides a data structure, a framework for the querying of that data structure, and a presentation layer responsible for the interactive manipulation of that data via the use of standards enabling the data to be replaced, or the presentation to be replaced, which produces a highly customizable interactive presentation of data via re-used modules. The computer system includes a database and database access module to support information about sets of members of an organization with static and time-varying information. The computer system provides an application programming interface that abstracts the re-usable aspects of the database and also provides a set of functions that streamline the development of new visual presentations of that data. The computer system provides for the playback of interactive scenes which each use novel interaction techniques to present entities (organizations, groups, individuals, and associated media) that have been pulled from the database by the framework; the interchangeable nature of the databases and presentation layers allow different interaction models to be used with different templates driven by different data. The computer system also includes image processing that can operate automatically on a large volume of images to apply effects to those images without manual intervention. As a particular example, a morph effect can be applied to a time-ordered sequence of images of an individual to generate a video representing changes in the individual's appearance over time. Such a morph effect uses automatically generated correspondence points within each image.

### CROSS-REFERENCE TO RELATED APPLICATIONS

This application is a non-provisional application claiming priority to prior filed provisional application Ser. No. 62/450,068, filed Jan. 24, 2017, entitled “COMPUTER SYSTEM FOR MANAGING DIGITAL MEDIA OF AN ORGANIZATION”, which is hereby incorporated by reference.

### BACKGROUND

An organization of people, such as a school, sports team, musical or other performing arts group, or company or other entity representing a group of people, generates many photographs of the people that are members of the organization over time. Commonly, such an organization hires a photographer for a “picture day”, when the photographer takes portraits of the members of the organization. The portraits typically have the same background. An organization also may have collections of other photographs of its members. The photographs from a picture day are commonly used for such things as yearbooks, directories, newsletters, memorabilia and the like. Yet other digital media may be generated such as videos.

With a large collection of digital media content of members of an organization over time, it is generally desirable for the organization to make the collection available, with limitations, to its members for various limited purposes. Such purposes can include, but are not limited to, directory access, generating memorabilia, ordering prints, sharing pictures and videos with both members and non-members, and the like.

### SUMMARY

This Summary is provided to introduce a selection of concepts in a simplified form that are further described below in the Detailed Description. This Summary is intended neither to identify key or essential features, nor to limit the scope, of the claimed subject matter.

To provide a computer system that appropriately limits access and use to digital media of an organization, and that associates sufficient member data with the digital media to allow browsing, navigation and selection, in a manner that provides some informational context to the digital media, involves several technical problems. One technical problem to solve with such an implementation arises because a person who is a member of an organization may have information that changes over time, such as a role or membership in a subgroup. For example, a student in a school belongs to different classes in different years. As another example, a teacher in a school may teach different classes in different years. As another example, leadership of an organization, such as people filling roles of a president or treasurer, may change as well. As another example, different people may be in different positions of a sports team, whether a coach or a player. Thus, a technical problem that arises is providing an adequate data structure, and corresponding query processing, to support both efficient storage utilization and efficient processing when performing queries.

Further the computer system should provide useful features for browsing collection of the digital media. For example, it could be desirable for the computer system to have different templates for displaying subgroups of members of an organization. Such templates should be customizable. The computer system provides an application programming interface that separates the interaction model of templates for viewing digital media for groups of individuals from queries on the database, allowing different interaction models to be used in different templates.

The computer system also can include image processing that can operate automatically on a large volume of images to apply effects to those images without manual intervention. As an example, a morph effect can be applied to a time-ordered sequence of images of an individual to generate a video representing changes in the individual's appearance over time. Such a morph effect uses automatically generated correspondence points within each image.

In the following description, reference is made to the accompanying drawings which form a part hereof, and in which are shown, by way of illustration, specific example implementations. Other implementations may be made without departing from the scope of the disclosure.

### BRIEF DESCRIPTION OF THE DRAWINGS

FIG. 1 is a block diagram of an example computer system for managing media.

FIG. 2 is a data flow diagram of an illustrative example implementation of a media management application.

FIG. 3 is a diagram of an illustrative example implementation of a database for managing media.

FIG. 4 is a graphical illustration of an example implementation of a database for managing media.

FIG. 5 is an illustration of an example graphical user interface for displaying a collection of digital media.

FIG. 6 is an illustration of an example graphical user interface for displaying a collection of digital media.

FIG. 7 is a data flow diagram of an illustrative example implementation of a morphing application.

FIGS. 8A and 8B are a collection of illustrative examples of correspondence points in digital images.

FIG. 9 is a flowchart of operation of an example implementation of a morphing operation.

FIG. 10 is a block diagram of an example computer.

### DETAILED DESCRIPTION

As used herein, a photograph is a picture made using a camera, in which light is focused by an optical lens onto a light-sensitive material or device, such as film or a charge-coupled device (CCD), to generate an image on the light-sensitive material or device, which image can be made permanent in the light-sensitive material and/or is digitally stored. A “digital still image” as used herein is a photograph that is digitally stored as an optionally compressed n X m array of picture elements, called pixels, each of which is represented by data representing one or more color components. A “digital video stream” as used herein is a time-based series of frames representing motion, with each frame stored as an optionally compressed digital still image. “digital media content” refers collectively to digital video streams, digital still images, and other digital media such as audio data, uniform resource identifiers (URI), uniform resource locators (URL) and/or text.

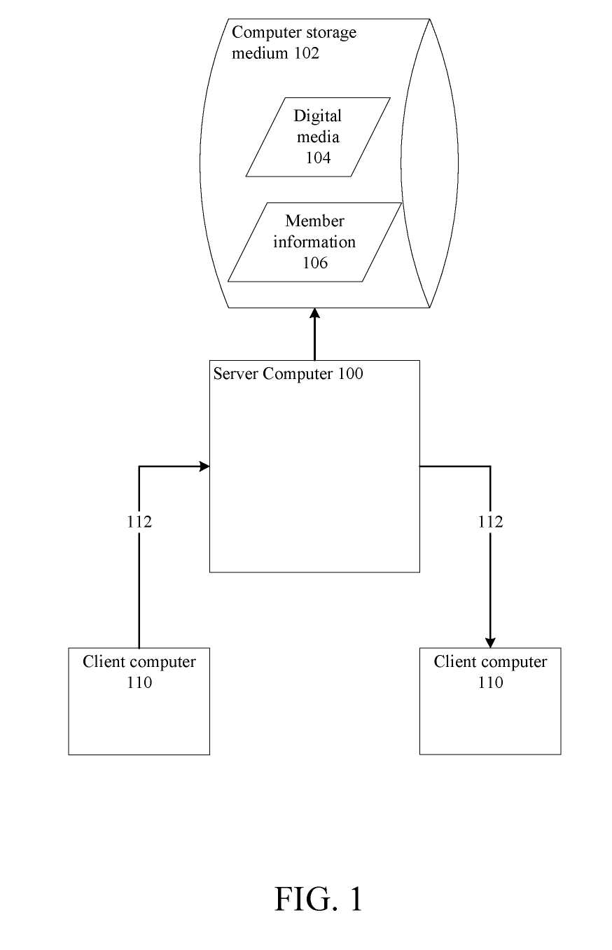

FIG. 1 is a block diagram of an example computer system for managing digital media, such as photographs, in such a context.

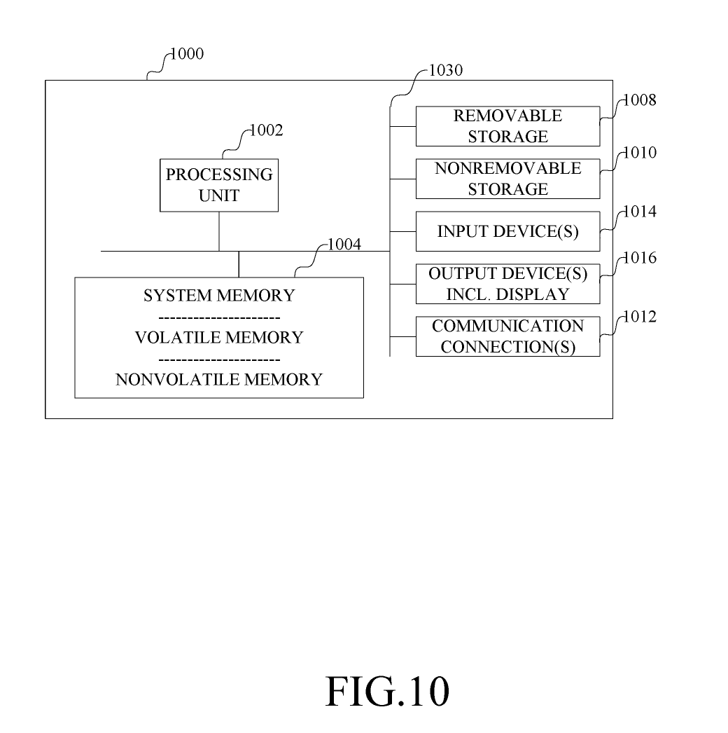

Such a computer system can include a server computer 100. The server computer 100 generally accesses a computer storage medium 102 in which data is stored. The data stored can include digital media content 104 and member information 106. The server computer 100 can be implemented using one or more general purpose computers, such as described in connection with FIG. 10, configured to implement one or more server computers. A server computer can be maintained for a single organization, or the server computer can be shared over multiple organizations. In some instances, the server computer can be maintained for a photographer that provides services to multiple organizations. In some instances, the server computer can be maintained for multiple photographers, each of whom provides services to one or more organizations.

The digital media content and member information can be stored in data files on the computer storage medium, in a manner accessible through a file system. The digital media content and member information can be stored in databases on the computer storage medium, in a manner accessible through a database management system. Such a database may store data, such as the digital media content, in data files that the database management system accesses through the file system of the server computer.

The server computer 100 is responsive to requests from client computers 110 over one or more computer network(s) 112, such as the internet or a private computer network, to access the digital media content 104 and member information 106. Such access can include requests to create, add and/or update the digital media content 104 and member information 106. Such requests can come from members of the organization and/or photographers and/or other individuals who act on behalf of the organization. Such access also can include requests to browse, read and select the digital media content 104 and member information 106, which in turn may lead to further transactions, such as purchasing prints or other products.

A client computer 110 can be implemented using a general purpose computer, such as described in connection with FIG. 10, configured as a client computer running one or more applications, such as an internet browser application (not shown). Examples of such a computer include, but are not limited to, a tablet computer, a notebook computer, a desktop computer, an interactive digital display at a kiosk or wall hanging, and a mobile phone including a computer and applications.

The computer network 112 can be any computer network that interconnects computers to enable communication among them, such as a local area network or a wide area network. Such a computer network can be private and/or publicly accessible, and can include wired and/or wireless connectivity. The computer network can be implemented using any of several available network communication protocols, such as, but not limited to, Ethernet and an Internet Protocol (IP) with one or more other protocols running on top of those protocols.

In this context, an application on the client computer is a computer program executed on the client computer which configures the client computer to be responsive to input (not shown) to allow a user to interactively browse the digital media content and member information stored on the server computer. The application displays or otherwise presents output data, such as a graphical user interface including digital media content and member information, through output devices (not shown). In the example described below the application on the client computer can be a browser application such as an EDGE or INTERNET EXPLORER browser from Microsoft, a CHROME browser, a SAFARI browser, a FIREFOX browser or other standard browser application. In such an implementation, the server computer generates data to be rendered in the browser application in response to input data received from the browser application.

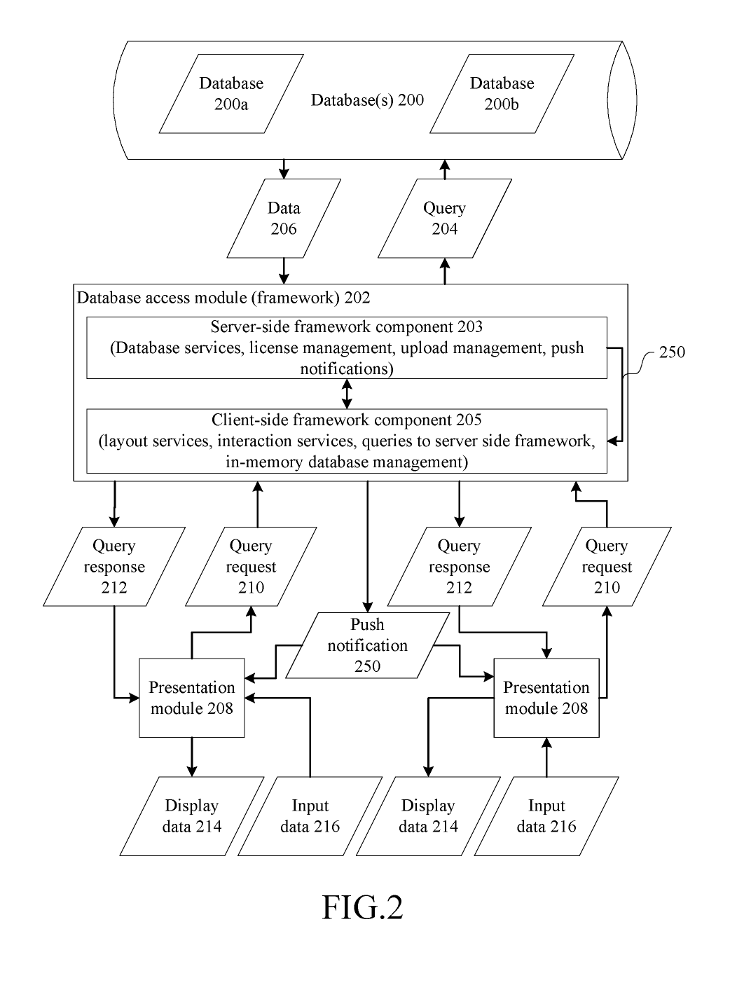

An example implementation of the server computer and client computer will now be described in connection with FIGS. 2-4. It should be understood that this is just one example implementation, and that many other implementations are possible.

FIG. 2 is data flow diagram of an illustrative example implementation of a media management application running on a server computer and a client computer. The media management application, and its components, can be implemented as one or more computer programs running on the server computer or client computer. The media management application accesses a database 200 of organization information accessible from the server computer. The database 200 includes the digital media content 104 and member information 106 (FIG. 1) for an organization.

The database 200 includes two sub-databases labelled 200a and 200b. For ease of administration a single large database handling all clients and organizations is preferred; however one can consider the database for two clients as conceptually independent; for example a sports team held in database 200a and a school represented by database 200b are separate in that changes made to one do not affect the other. 200a and 200b may contain fields in common (for example, individuals may have first and last names whether they are on a team or in a classroom) but they also have usage-specific fields such as player jersey number or position (for team players) or home room and grade (for students).

A database access module 202 provides services for accessing a database 200. In particular, the database access module 202 implements queries 204 that retrieve data 206 from the database 200.

One or more presentation modules 208 use the database access module 202 to access data from the database 200. A presentation module is used to generate an interactive presentation of a database. A presentation can incorporate any desired two-dimensional or three-dimensional model including a layout of one or more digital media content and associated member information based on data received through the database access module 202. In one implementation described in more detail below, the database access module 202 is divided into a server-side component 203 and a client-side component 205, in which case the presentation module is executed on the client computer. The server-side component can provide services such as database access, licensing status information, upload management, and push notifications 250, as described in more detail below. The client side component can provide services such as layout services, interaction services, database queries to the server and maintenance of an in-memory database.

A presentation module can be implemented as a WebGL project, which can be edited using the PlayCanvas development engine. As a WebGL project, a presentation module can reside on a server computer to be accessed by a client computer using a uniform resource locator (URL) for the WebGL content. Such a URL can specify a presentation module, a database for an organization and other information (such as an individual within the database), and can indicate if the URL is being accessed to provide privately-accessible data or publicly-accessible data. The presentation module is then transmitted to the client computer where it is processed by and run in a browser application. When processed in the browser application it generates display data on the client computer and requests data from the database access module on the server computer. For example, the presentation module may pull images from the database 200 and presenting them as textures on 3D objects in an interactive 3D context for the user to navigate.

A presentation module provides a query request 210 to the database access module to request data from the database. In response to the query request, the database access module 202 submits one or more queries 204 to the database 200. In response to queries 204, the database provides data 206. In turn, the database access module 202 processes the received data 206 into a query response 212, which is provided to the presentation module 208. In turn, the presentation module 208 processes the received query response 212 into display data 214 according to the layout created by the presentation module. The presentation module receives input data 216 in response to user interaction with the display data, for example through a browser application.

As shown in FIG. 2, the system can include multiple different presentation modules accessing the same database through the same database access module. FIG. 2 also can be understood to indicate that different server computers can be built using the same database access module for use with different presentation modules and/or different databases. Also, the same database access module can be used to access different databases on the same server computer. Such interchangeability can be provided by having the database access module implement an application programming interface (API) to which each database and each presentation module conforms.

The ability to “swap” databases, for example 200a for a different sports team, is a desirable aspect of the current invention; a presentation module 208 expects certain fields to be present in the database. A database 200a which is compatible with a given presentation module 208 can be replaced with a new database 200b without disruption for the presentation

In addition, two different presentation modules accessing a same database access module (or different instantiations of a same implementation of the database access module) can implement significantly different layout models and/or interaction models. In particular, in response to input data 216, a presentation module changes a current view of its layout interactively. Different presentation modules can make such changes in different ways in response to input data 216. For example, one presentation module may present individuals physically arranged into a circle, with interface gestures causing the viewer's position to rotate around that circle; another presentation module may present individuals as a flat scrolling list, with interface taps navigating to the next or previous individual. Each presentation is flexible both in the visual presentation (colors, shapes, effects) and the interactive logic (swiping, tapping, dragging) used to present the content found in the database.

In one implementation, the database 200 for an organization can be implemented using JSON. A filter can be applied to extract data from this data for a subset of the database, such as for a single individual, single group or cohort. The query response 212 from the database access module to the presentation module can be generated by applying such a filter. In turn a significantly reduced JSON database for the selected subset can be provided to the presentation module. The presentation module can be implemented so as to issue another query request only when the input on the client computer indicates a request for data that is not included in the original query response 212.

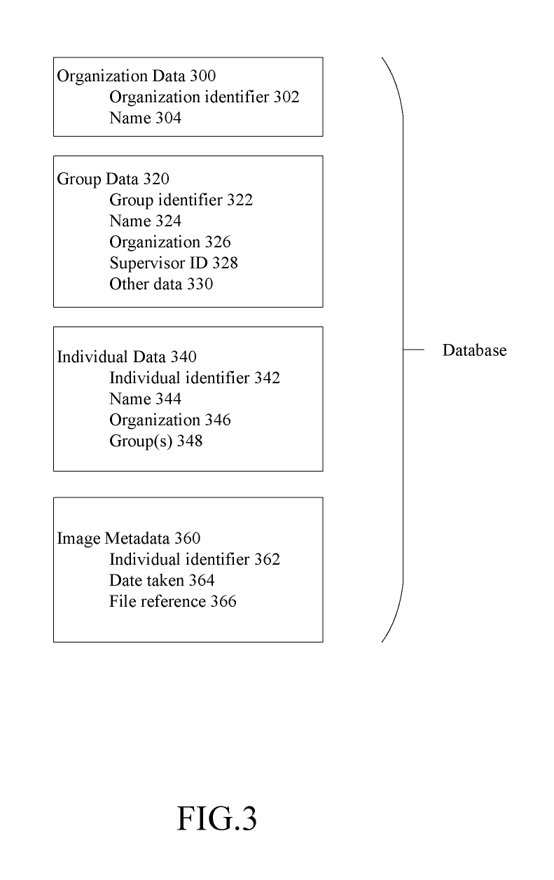

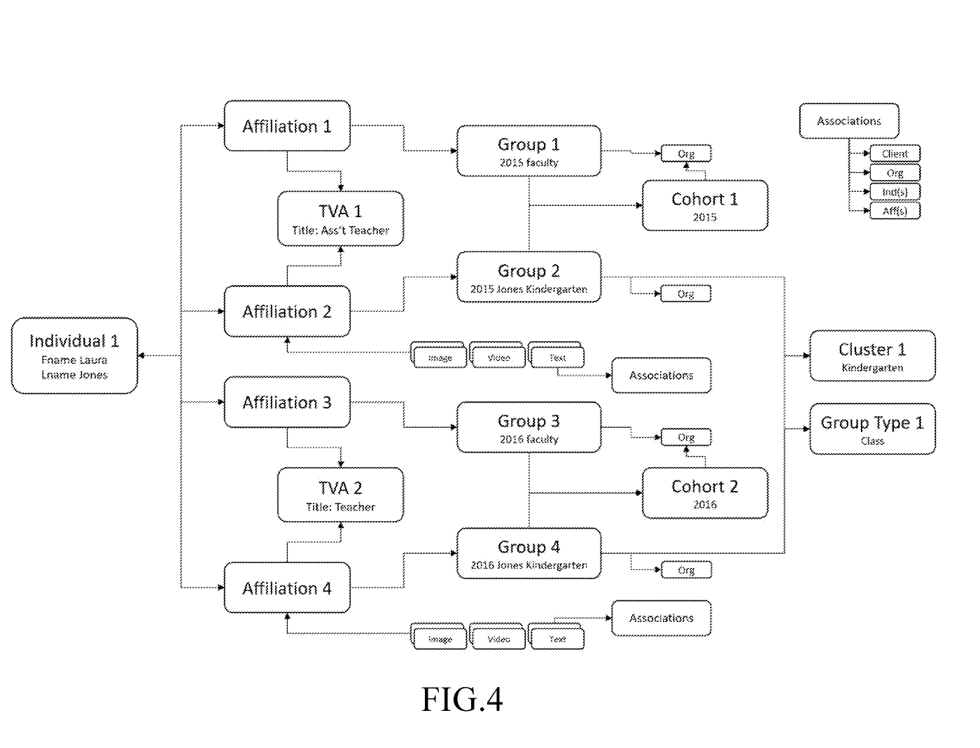

Having now provided an overview of operation of an example implementation, an example implementation of a database will now be described in more detail in connection with FIGS. 3 and 4. The data as shown in FIG. 3 can exist in a database or data file in persistent storage or can exist as a data structure in memory. For example, the data can be stored in a database, for example in a key-value pair format, a relational table format, or in a static file such as eXtensible Markup Language (XML) or other markup language, JavaScript Object Notation (JSON), or similar formats.

Generally speaking, as shown in FIG. 3, data about members of an organization includes organization data 300 representing the organization, group data 320 representing groups of individuals within the organization, and individual data 340 representing individuals within the organization, metadata 360 for digital media content which can be associated with any entity within the database (organizations, groups, individuals, etc.) stored in the computer system.

An organization is a top-level collection of individuals, which can be arranged into groups. Each organization has an organization identifier 302 and a name 304. Examples of an organization include, but are not limited to, a school, sports team, musical or other performing arts group, or company or other entity representing a group of people.

A group is a collection of individuals, which can be associated with an organization. Each group has a group identifier 322 and a name 324. A group may include data identifying an individual who is a supervisor 328 of that group, such as the identifier of the individual who is a coach of a team, or teacher of a class. Other data 330 about a group also can be stored. Examples of a group include, but are not limited to, a class in a school, such as the 2016 kindergarten class with a particular teacher, or a set of employees in a department.

An individual is a human being. Each individual has an individual identifier 342 and a name 344.

In each case, additional application-specific information can be associated with individuals, groups and/or organizations. For example, “title” is applicable to a principal at a school, while “position” is applicable to players on a sports team.

The system manages digital media associated with entities in the database. The actual media is stored as data files on the computer storage in the computer system, while metadata about such media, associates the data files with the data about the entity found in the database. For example, the image metadata 360 can include an individual identifier 362 for the individual in the image, a data taken 364 for the image, and a reference 366 to the data file that stores the image data.

Data for a group can include a reference to the organization 326 of which the group is a part. Similarly, data for an individual can include a reference to the organization 346 and one or more groups 348 in that organization to which the individual belongs. Such a reference 348 can be implemented by way of the affiliation and time-varying attribute data structures described below. Membership of an individual within a group or an organization, and association of a group with an organization, alternatively can be tracked by way of relational tables with entries that associate an individual identifier with a group identifier or organization identifier and related metadata, and that associate a group identifier with an organization identifier.

Additional data structures can be used to identify additional groups, such as a group of groups within an organization. Herein, such a group of groups is called a “cluster”. For example, for a school, a specific grade 3 class is a group; all grade 3 classes can belong to a cluster representing the set of all grade 3 classes. The data in FIG. 3 can be augmented to include data representing a cluster, which can include an identifier for a cluster. For each group in that cluster, additional data for the group can include the identifier for any cluster in which the group is included.

Another kind of group is called a “cohort” herein. A cohort has a unique identifier and describes a subset of the members of an organization. Data for a group or for an individual can reference a cohort. A cohort can represent, for example, but not limited to, a year, such as a school year (“2016-2017”), or other period of time, such as a sports season (e.g., “Fall 2016”). For example, all members of the organization in a given year can be members of a cohort for that year. The computer system can use cohorts, for example, to define portions of a database to which an individual can have access. As an example, an individual may be in a cohort of “2014” and not be granted access to see information associated with the cohort of “2016”.

The database also can include structures that associate time-varying information with individuals and groups. In particular, some information about an individual is, usually, static, such as the person's name. However, some other information changes over time, such as a title or role of an individual within an organization. For example, a teacher may be an assistant teacher one year, and a teacher another year. Or, a student is in kindergarten one year and then first grade the subsequent year. A player on a sports team may play one position one season, and another position in another season.

To capture such time-variant data, the database includes a first data structure called a time-varying attribute, and a second data structure called an affiliation. A time-varying attribute is any property or attribute that may vary over time for an individual. When entering data into the database, one recognizes such data is not a property of the individual but instead is a property that is temporarily associated with the individual during a period of time. An affiliation data structure associates an individual, a group and a time-varying attribute. A single affiliation can be provided for each group in which an individual is a member. In one example, a group may be a particular class in a school, such as the 2016 first grade class. An individual can be a member of that group, such as a student or teacher. A time-varying attribute can be, for example, the role of teacher.

The database also can include data that associates entities in other ways. For example, the database can include information about photographers and associate photographers with the organizations the photographers have as clients.

FIG. 4 is an illustrative example of how entities in a database for an organization (“org” in FIG. 4) as described above can be interrelated. “Individual 1: represents an individual (Jones) in the database. Group 1 is defined for 2014 faculty and Group 2 is defined for the 2015 class taught by Jones. Group 3 is defined for 2016 faculty and Group 3 is defined for the 2016 class taught by Jones. Groups 2 and 4 are associated with Cluster 1, which represents all Kindergarten classes. Groups 2 and 4 also are associated with Group Type 1, which indicates a type of the group, which in this case is a class. Cohort 1 represents the organization for 2015; Cohort 2 represents the organization for 2016. The various groups and cohorts refer to the organization (“org”).

Time-varying attribute (TVA 1) represents teacher Jones' title of “assistant teacher” (“ass't”) in 2015; another time-varying attribute (TVA 2) represents teacher Jones' title of “teacher” in 2016. Affiliation 1 associates individual 1, group 1 and TVA1; Affiliation 1 associates individual 1, group 2 and TVA1. Affiliation 3 associates individual 1, group 3 and TVA2; Affiliation 4 associates individual 1, group 4 and TVA2.

Various associations can associate image data, video data and text data, or other digital media data, with other any of these objects. The image data, such as a portrait of an individual taken in a given year, can be associated with the affiliation object that associates an individual with a group.

To support the interchangeability of databases with a presentation module, a database conforms to a standard format. Such interchangeability works not merely between databases of the same type (e.g., “sports”) but also between different types (e.g., “sports vs school”). This interchangeability can be accomplished via a structure such as shown in FIGS. 3-4. The core, common elements are individuals, groups and organizations. The standard for the database can be further refined to also include time-varying attributes and affiliations.

As noted above, data representing an individual is data about a human being. An individual has certain reliable fields such as first name and also optional application-specific fields such as rank, position, jersey number, home room, student number, etc. Templates (i.e., presentation modules) will frequently make use of optional application-specific fields. A given individual not having a value for an optional field, e.g. a baseball player not having a grade, does not result in a failure of operation of the presentation module. The existence of an individual as a standard entity enables an ‘individual view’ which presents information about an individual, such as a baseball card for each member of a baseball team, as well as populating the contents of group views, such as class composites or team memory mates or other common presentations in school and sports photography.

Also as noted above, data representing a group represents a set of individuals. Optionally a group is associated with an organization (a school) and a cohort (2015). For example, Mrs. Jones's grade 4 class at central secondary for the year 2015 can be separate from her same class in 2014, and can appear in a list of all classes taught at that school in 2015. The existence of a group as a standard entity enables a ‘group-level view’ which collects all individuals in a group into a single list for presentation, whether they are players on a team or students in a class.

An organization in the database is an entity with a name with which groups are associated. For example, classes are associated with school organizations; teams are associated with league organizations. The existence of an organization as a standard entity enables an “organizational0-evel view” which collects all groups (classes/teams), optionally condensing them into clusters, such as “all grade 3 classes”.

Time-Varying Attributes (“TVA”) can be a standard entity for the database. As noted above, time varying attribute are set of fields whose contents vary over time. For example, a teacher's position within a school might change from assistant teacher to full teacher; a camper at a day camp might be hired as a counselor in a subsequent year. Time-varying attributes are not required for database interchangeability but they provide an elegant answer to the question of where to store information that changes based on a group and an individual to which references are being made. A presentation module 208 that consumes TVAs can support swapping databases, particularly if the TVA contents conform to expectations, e.g. sports-specific fields in a TVA mapping to text fields displayed in a sports-themed presentation module.

The affiliations, which provide connections between an individual and a specific group, and a TVA, also can be standard entities in the database. Using affiliations, each individual has a unique affiliation entity for each group of which they are a member. For example, a teacher who is a member of a grade 3 class group and also a member of the administration group for a given school will have two affiliations for that year. Affiliations are not required for database interchangeability but they provide a graceful answer to the question of how to efficiently associate media such as photographs with a specific individual and group. For example, a photograph database entry might store the ID of an individual present in the photograph and the name of the group of which the individual was a member; however, using an affiliation concisely specifies that the photo is of a specific individual in a specific group, which is associated with a specific cohort of a specific organization. A presentation module 2016 that uses affiliations can easily filter database contents to show only relevant content with an efficient query.

An association, which is a connection between a database entity, such as a photo, a video, etc., and another entity, also can be a standard database entity. An association may contain zero or multiple references to clients, organizations, individuals or affiliations. Associations are not required for database interchangeability but they provide flexibility for connecting media with arbitrary entries in the database. A presentation module 216 that uses associations can reliably present a variety of content regardless of the database with which the presentation module is connected.

The interchangeable nature of databases that conform to a data standard used by presentation modules provides significant advantages in developing and deploying different databases and different presentation modules. A given presentation module 208 might be best suited for a baseball team: it looks for TVA fields like “field position” and “jersey number”, and presents the team arranged on a virtual baseball field. However this template will not fail when presented with a school database: the organization will be a school instead of a league, the group will be a class instead of a team, an individual student will have TVAs containing student numbers etc. and no information on jersey number, but this is not an error. As a result, the baseball-themed presentation module 208 will be able to represent the entire school/league, and support navigation from the school/league to a specific class/team, and from the class/team to a specific student/player. The fields that are not present in the TVAs stored in the database will produce empty slots in the visual presentation, and the lack of ‘position on field’ may require the presentation module to fall back on default placements for individuals in the 3D scene, but the presentation still functions.

Returning now to FIG. 2, more detail about the client-side and the server side of the database access module will now be described. These components provide a framework which exposes services that are consumed by the presentation modules. These services can include, but are not limited to, database access, layout operations, interactions, menu systems, electronic commerce, policy implementation, upload management and push notifications.

Regarding database access, the framework manages database queries on behalf of the presentation module; the specifics of how the main database 200 stores the content are hidden from the presentation module. This structure allows the main database to be relocated, or rewritten in a different technology, or split into multiple parts, without affecting presentation modules. The framework also pre-processes the main database to a minimum size for efficient communication with the presentation module 208. For example, it is not necessary to transmit an entire school database in order to view a specific individual's page in the presentation module, particularly if the presentation is launched using a URL which should only allow the user to see that one individual. Similarly, the main database may maintain information which is not useful to the presentation module, such as the original filename of user-uploaded media. The database also may provide multiresolution caching services, meaning that the filename of the original media is irrelevant.

Regarding layout services, the framework can provide specific configurations of layout elements, such as individuals arranged into a circle or a grid, which are common to multiple presentation modules 208. Implementing these arrangements “in the framework” one time and having presentation modules access these existing implementations is more efficient than re-implementing for each new presentation module being designed. As an example, the layout service can provide a three-dimensional object that arranges objects representing individuals in a ring have a diameter that expands based on the number of individuals represented in the ring. As another example, the layout service can provide an object that arranges images into a cylindrical arrangement of placeholders, where the cylinder is of fixed dimension and rotating around a camera under user control. In this layout, the image contents of each placeholder are dynamically substituted when that placeholder has been carried “offscreen” (e.g. behind the virtual camera) by rotation of the cylinder—producing the effect of scrolling through a list of variable length even though the actual scene geometry remains restricted to a fixed number of placeholders.

Regarding interaction services, the framework can provide predetermine navigation results in response to specific gestures received by the presentation module. For example, when a user is looking at content for one individual, the user may choose to navigate up to the group or to the next/previous individual in the current group. The user interface interaction model exposed by the presentation module may be common. For example, a left-right swipe, or tapping an overlaid “next” button, may be gestures used to visit the next individual in a group. The presentation module 208 can be implemented with such functionality native to the presentation module. Alternatively, if such functionality is offered as a prebuilt method in the framework, a presentation module can use the implementation provided in the framework.

Similarly, a consistent set of functions, such as menu systems, can be made available for various types of presentations. Such menu system can provide functions such as uploading user content, purchasing premium membership, and sharing content via social media. The framework can expose menu structures which handle these operations without additional effort by the presentation module.

The framework also can provide electronic commerce related information. For example, users of presentations may have different payment/membership status. In one implementation, users can be in one of three states: public, free member or paid member. A public member is an anonymous user who has received a link to view a specific individual and who has not logged in or otherwise been authenticated. A free member is a user who is known to be a member of an organization, e.g., a parent of a student at a school, who has not paid anything to experience a presentation. A paid member is a member user who has paid to enjoy an expanded set of services, such as the right to share a presentation by social media or upload their own content. The server side framework is responsible for tracking the status of individuals, while the client-side framework exposes login dialogs and responds to authentication status reported by the server.

The framework also can implement policies. For example, a school may allow members to navigate the database hierarchy while disallowing such navigation by public users. A real estate office may allow navigation of the database hierarchy without signing in, as the presentation may be viewed as marketing materials. Such interpretation of policy is best left to the framework, although presentation modules can re-implement policies if appropriate.

The framework also can provide services to manage uploads of content to the database. For example, users may be allowed to upload personal content such as candid photographs. The framework provides services for the media to be uploaded, for the database to be expanded to include the new media, for associations between that media and individuals, groups, affiliations, or other entities in the database, to be formed.

The framework also can provide services to support push notifications. Some applications of the framework involve real-time ‘push’ updates to presentation modules. For example, at a football game, when a touchdown is scored by a particular player, the framework can push an update to all listening client applications that features that player's individual page, or can push an update of that player's play statistics, can push an update to present a new score for the game. How a presentation module displays the pushed information to the user can be defined by the presentation module, but the framework provides the service to generate the notifications.

Given such a framework, each presentation module can be implemented as a client-side application which takes media and database entries from the framework and presents it for interactive consumption by a user. In one implementation, a presentation module can be developed using PlayCanvas, a platform for presenting 3D information. The framework mechanism allows creation of a library of presentation modules which expose content with completely different visual styles and interactive mechanisms. Other platforms with which presentation modules can be created include Flash or Silverlight or HTML5 or SVG or similar.

Presentation modules are by design crafted to appeal to specific markets or functional requirements. A baseball team may best be illustrated with a high-energy presentation similar in style to the bumper graphics shown during televised sports broadcasts, while a presentation intended for elementary schools might be relatively childish with colorful and playful design choices. Beyond visual style, presentations also can have different interaction models, meaning that different user gestures can result in different behaviors between different presentation modules. For example, swiping left or right might navigate from student to student in a grid for a school presentation, while the same action might orbit a stadium with a 3D presentation of all players for a sports presentation.

Unlike interactive three-dimensional game engines, where three-dimensional models may allow changes in textures, background scenes, character model parameters, and animation parameters, such game engines generally provide the same interaction model. In contrast, the framework described above allows each presentation module to define its own interaction model in addition to its own layout of the information. Thus, as an example, a class at a school can be presented in a presentation module originally designed to present a football team; a football team can be presented in a presentation module originally designed to present a class at a school. The change can occur merely by changing the database accessed by the presentation module. The framework provides a consistent interface for each presentation module to access databases for organizations in a consistent way.

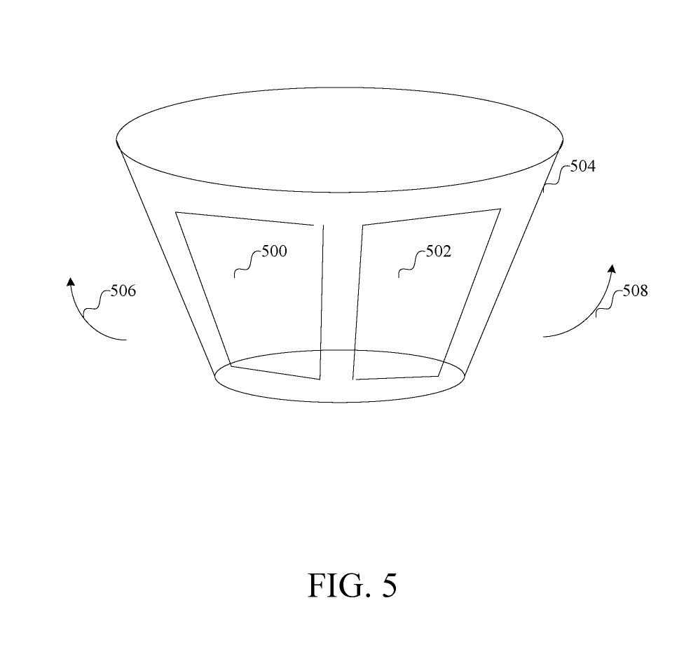

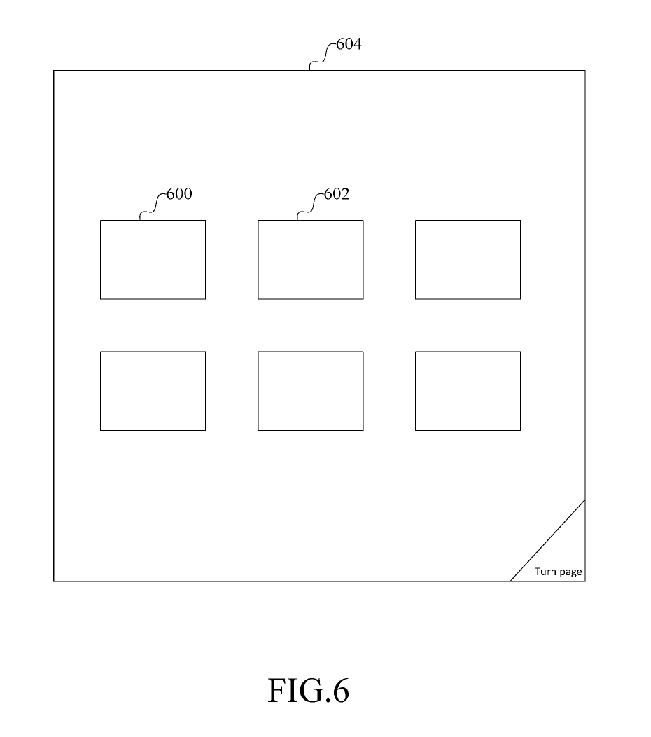

FIGS. 5 and 6 illustrate example graphical user interfaces which can be generated by different presentation modules for viewing the contents of a database.

Given the operation of the database access module, presentation modules for viewing the contents of the database can provide different interaction models, i.e., different behaviors in response to user inputs. FIGS. 5 and 6 illustrate two different interaction models.

The first interaction model in FIG. 5 includes images 500, 502 presented in a partially conical arrangement, as if on a surface of a partially conical three-dimensional shape 504. A similar format may be based on a cylindrical shape. A similar format may be based on a pyramid shape, to provide a visual effect like a “jumbotron” or scoreboard in an arena. In such a display, the shape on which the images presented may be a visible object or may be invisible. In this interaction model, a user may cause the displayed images to rotate in directions 506, 508 through an appropriate gesture in the user interface.

The second interaction model in FIG. 6 includes images, e.g., 600, 602, presented as if they are on pages in a book 604, which can be implemented as a three-dimensional shape for which pages can appear to turn. In such a display, the shape on which the images are presented may be a visible object or may be invisible. In this interaction model, a user may cause a page turn to occur through an appropriate gesture in the user interface.

Given the foregoing example implementation, a variety of image processing effects can be applied to images displayed in the graphical user interface. Such effects can be part of a primary display, such as in FIG. 5 or FIG. 6, or can be selected to be applied to one or more images of a selected individual, for example.

One of the image processing features that can be made available in this system is a video generated by applying a morphing algorithm to a time-ordered sequence of still images or videos of the same individual taken at different times. The resulting “morph” illustrates the physical development of a player or student as they grow and develop over the course of several years. This system can include a morphing application which automatically generates such videos given the set of media available for an individual.

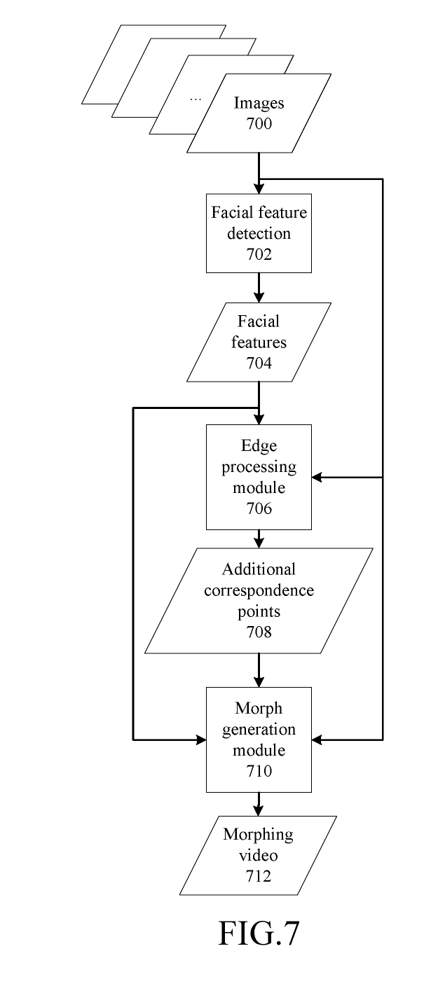

An example implementation of such image processing will now be described in connection with FIGS. 7-9.

FIG. 7 is a data flow diagram of an illustrative example implementation of a morphing application. A set of images 700 for an individual are provided. Each of these images is input to a facial features detection module 702. Using components of a facial recognition algorithm, characteristic points in the image are identified in the facial part of the image, noted as facial features 704.

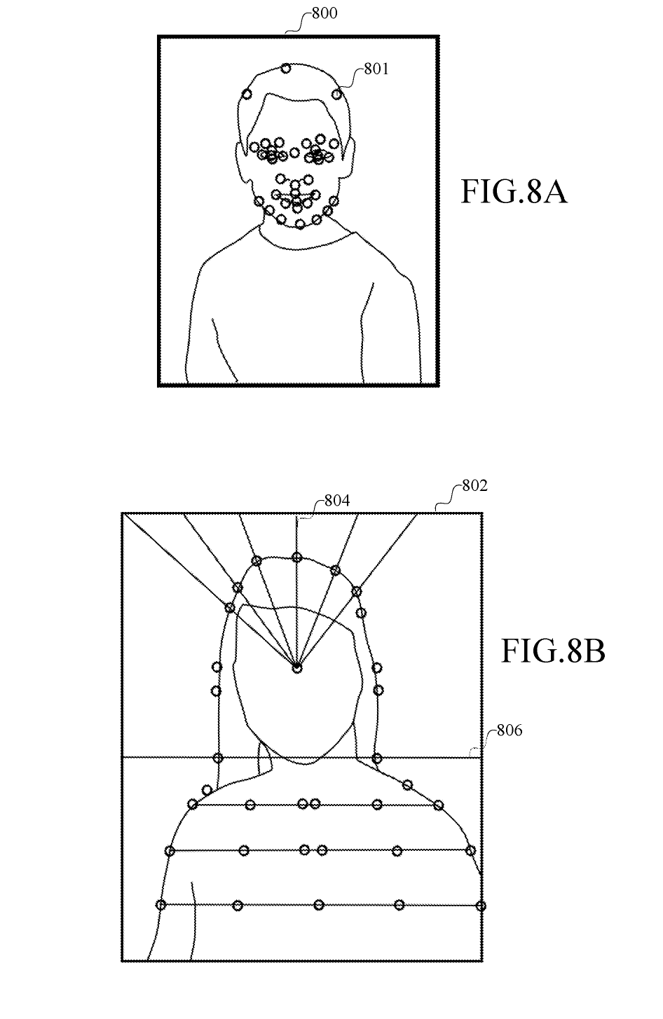

As shown in FIG. 8A, in the image marked 800, such characteristic points are shown by circles, e.g., 801, and generally include the corners of the eyes, points along the circumference of the eyes, points along the eyebrows, the centers of the eyes, the bridge of the nose, the tip and edges of the nose, the corners and center of the mouth, points along the top and bottom lips, and points along the chin. Points on the top of the head also may be obtained. An example of a facial recognition computer program that can be used for this purpose is FaceSDK application published by Luxand, Inc., of Alexandria, Va.

The facial features extracted for an image, shown at 704, and the image 700 from which they were extracted, are input to an edge processing module 706 which identifies additional correspondence points 708 along the boundary between the individual and the background. These additional correspondence points allow for unattended generation of a morph animation because their presence ensures smooth and realistic morphing between images. If no additional correspondence points are present to define the edge of the subject's hair, or shoulder positions, then morphs tend to produce unrealistic distortions of the subject's body which distract from the realism of the “young to old” effect that the morph presents.

Such processing can be performed in a number of ways. Generally speaking, an edge correspondence point is a point at an intersection of a boundary between the foreground and background and a ray directed from a standard point in the foreground. In one particular implementation, given a ray from an edge of the image, in the background part of the image, to a selected point, such as the bridge of the nose, the computer processes each successive pixel along the ray from the background towards the facial feature until a sufficiently large change in the pixel data occurs, suggesting the presence of the edge. A plurality of such edge correspondence points are obtained.

Examples are shown in FIG. 8B with image 802. In this example, several rays 804 are directed radially from the bridge of the nose over a range of 90 degrees, centered on a vertical line in the image. In addition, two rays 806 are directed horizontally, left and right, in the image, from the bottom of the chin. Additional horizontal rays, left and right, can be directed from additional points below and vertically aligned with the bottom of the chin. Additional points along these horizontal rays also can be used as additional correspondence points provided as input to the morphing algorithm.

It should be understood that there are several ways to identify the additional edge points and the invention is not limited to the examples shown in FIGS. 8A and 8B. In some implementations, the additional points can be found using transparency information associated with the image, such as an alpha channel or other information defining an end between the background and the foreground in an image. In some implementations, the additional points can be found using attributes of the red, green and blue channels of an image.

However, many portrait images of individuals that are commonly taken in practice have a background that is not a “green screen”. Backgrounds come in a variety of colors and designs, such as sky-blue background with patches of white simulating clouds. Also, individuals have a variety of hair styles and colors. To provide an automatic way to identify the edge correspondence points in such cases, in one implementation, a dynamic adaptive thresholding technique is used based on a technique for IIR filtering used in audio processing. For each pixel along the ray, the computer computes a moving average of the hue and/or luminance of the previous pixels. For each subsequent pixel, the moving average is, and the pixel is compared to the weighted moving average. If the difference is over a threshold, then the edge is concluded to be detected. If the difference is not over the threshold, the threshold can be adjusted before processing the next pixel.

Returning to FIG. 7, the facial features 704 and additional correspondence points 708 computed for each image 700, as well as the images 700, are provided to a morph generation module 710. The morph generation module can be implemented as a computer program, such as the MorphLib library available on the GitHub open source repository, which can generate a video representing a morphing effect using the input correspondence points and the images 700. It should be understood that the images 700 should be presented as a time-ordered sequence (ordered based on the time when the image was taken), in order for the morph to represent the individual's growth or change in appearance over time. Such ordering can be performed by the morph generation module if a date is associated with each of the images, or can be performed by another computer program, or can be performed manually.

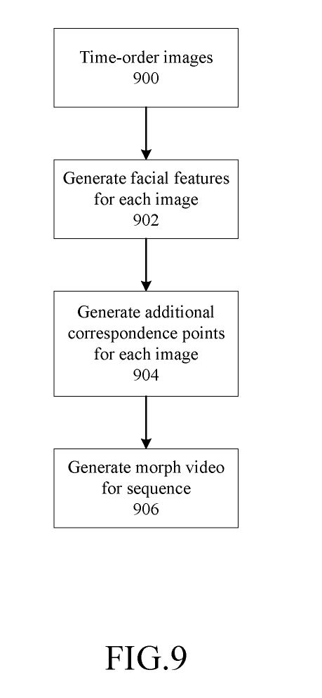

FIG. 9 is a flowchart of operation of an example implementation of a morphing operation. A selected set of images is time-ordered 900. The set of images may be selected, for example, in response to a selection of an individual through the graphical user interface. Alternatively, a computer program may generate videos using this morph effect as a background process for all individuals having images in the database. The set of images can be time-ordered by placing them in an ordered data structure in order by the date taken.

The images are processed to generate 902 facial features for each image. The facial features for an image, and the image, are inputs to additional processing to generate 904 additional correspondence points for each image. Given the additional correspondence points and the facial features, the morph effect can be applied to generate 906 a morph video for the sequence. The morph video can be stored and added to the database (in FIG. 3) in a manner associated with the individual.

It should be understood that the steps in FIG. 9 do not need to be performed in the sequence shown. For example, all images can be processed in batch to extract facial features. Similarly, all images can be processed in batch to generate additional correspondence points at any time after the facial features have been extracted. The set of images for an individual can be time-ordered at the time of the processing of the morph effect. The morph effect can be generated on demand when requested by a user interacting with the database.

Having now described an example implementation, FIG. 10 illustrates an example of a computer with which components of the computer system of the foregoing description can be implemented. This is only one example of a computer and is not intended to suggest any limitation as to the scope of use or functionality of such a computer.

The computer can be any of a variety of general purpose or special purpose computing hardware configurations. Some examples of types of computers that can be used include, but are not limited to, personal computers, game consoles, set top boxes, hand-held or laptop devices (for example, media players, notebook computers, tablet computers, cellular phones including but not limited to “smart” phones, personal data assistants, voice recorders), server computers, multiprocessor systems, microprocessor-based systems, programmable consumer electronics, networked personal computers, minicomputers, mainframe computers, and distributed computing environments that include any of the above types of computers or devices, and the like.

With reference to FIG. 10, a computer 1000 includes a processing system comprising at least one processing unit 1002 and at least one memory 1004. The processing unit 1002 can include multiple processing devices; the memory 1004 can include multiple memory devices. A processing unit 1002 comprises a processor which is logic circuitry which responds to and processes instructions to provide the functions of the computer. A processing device can include one or more processing cores (not shown) that are multiple processors within the same logic circuitry that can operate independently of each other. Generally, one of the processing units in the computer is designated as a primary processor, typically called the central processing unit (CPU).

The memory 1004 may include volatile computer storage devices (such as a dynamic or static random access memory device), and non-volatile computer storage devices (such as a read-only memory or flash memory) or some combination of the two. A nonvolatile computer storage device is a computer storage device whose contents are not lost when power is removed. Other computer storage devices, such as dedicated memory or registers, also can be present in the one or more processors. The computer 1000 can include additional computer storage devices (whether removable or non-removable) such as, but not limited to, magnetically-recorded or optically-recorded disks or tape. Such additional computer storage devices are illustrated in FIG. 10 by removable storage device 1008 and non-removable storage device 1010. Such computer storage devices 1008 and 1010 typically are nonvolatile storage devices. The various components in FIG. 10 are generally interconnected by an interconnection mechanism, such as one or more buses 1030.

A computer storage device is any device in which data can be stored in and retrieved from addressable physical storage locations by the computer by changing state of the device at the addressable physical storage location. A computer storage device thus can be a volatile or nonvolatile memory, or a removable or non-removable storage device. Memory 1004, removable storage 1008 and non-removable storage 1010 are all examples of computer storage devices. Computer storage devices and communication media are distinct categories, and both are distinct from signals propagating over communication media.

Computer 1000 may also include communications connection(s) 1012 that allow the computer to communicate with other devices over a communication medium. Communication media typically transmit computer program instructions, data structures, program modules or other data over a wired or wireless substance by propagating a signal over the substance. By way of example, and not limitation, communication media includes wired media, such as metal or other electrically conductive wire that propagates electrical signals or optical fibers that propagate optical signals, and wireless media, such as any non-wired communication media that allows propagation of signals, such as acoustic, electromagnetic, electrical, optical, infrared, radio frequency and other signals.

Communications connections 1012 are devices, such as a wired network interface, or wireless network interface, which interface with communication media to transmit data over and receive data from signal propagated over the communication media.

The computer 1000 may have various input device(s) 1014 such as a pointer device, keyboard, touch-based input device, pen, camera, microphone, sensors, such as accelerometers, thermometers, light sensors and the like, and so on. The computer 1000 may have various output device(s) 1016 such as a display, speakers, and so on. Such devices are well known in the art and need not be discussed at length here.

The various computer storage devices 1008 and 1010, communication connections 1012, output devices 1016 and input devices 1014 can be integrated within a housing with the rest of the computer, or can be connected through various input/output interface devices on the computer, in which case the reference numbers 1008, 1010, 1012, 1014 and 1016 can indicate either the interface for connection to a device or the device itself as the case may be. The various modules, tools, or applications, and data structures and flowcharts of FIGS. 1-9, as well as any operating system, file system and applications on a computer in FIG. 10, can be implemented using one or more processing units of one or more computers with one or more computer programs processed by the one or more processing units. A computer program includes computer-executable instructions and/or computer-interpreted instructions, such as program modules, which instructions are processed by one or more processing units in the computer. Generally, such instructions define routines, programs, objects, components, data structures, and so on, that, when processed by a processing unit, instruct or configure the computer to perform operations on data, or configure the computer to implement various components, modules or data structures.

In one aspect, an article of manufacture includes at least one computer storage medium, and computer program instructions stored on the at least one computer storage medium. The computer program instructions, when processed by a processing system of a computer, the processing system comprising one or more processing units and storage, configures the computer as set forth in any of the foregoing aspects and/or performs a process as set forth in any of the foregoing aspects.

Any of the foregoing aspects may be embodied as a computer system, as any individual component of such a computer system, as a process performed by such a computer system or any individual component of such a computer system, or as an article of manufacture including computer storage in which computer program instructions are stored and which, when processed by one or more computers, configure the one or more computers to provide such a computer system or any individual component of such a computer system.

It should be understood that the subject matter defined in the appended claims is not necessarily limited to the specific implementations described above. The specific implementations described above are disclosed as examples only.

What is claimed is:

1. A computer system comprising:
a database of organization information conforming to a schema and having a database interface,
a database access module operative to query the database through the database interface and having an access interface; and
a presentation module executing as a computer program on a computer and having a presentation interface to access the database access module, the presentation interface conforming to the access interface of the database access module;
wherein the database interface, access interface and presentation interface allow interchangeable compatibility among the database, the database access module and the presentation module such that any presentation module conforming to the access interface of the database access module can access the database and that any database conforming to the schema and having the database interface can be accessed by the presentation module through the database access module.

2. The computer system of claim 1, wherein the database tracks individuals as associated with groups, and groups as associated with organizations.

3. The computer system of claim 2, wherein associations of individuals with metadata include static associations.

4. The computer system of claim 2, wherein associations of individuals with metadata include time-varying associations.

5. The computer system of claim 1, wherein the database access module is operative to parse the database.

6. The computer system of claim 1, wherein the database access module is operative to filter the database to generate a list of entities from the database.

7. The computer system of claim 6, wherein the database access module in the access interface provides a filter as a service to the presentation module.

8. The computer system of claim 7, wherein the access interface provides navigation commands to access parts of the list.

9. The computer system of claim 1, wherein the access interface provides a plurality of predefined layout options.

10. The computer system of claim 1, wherein the presentation module generates display data from data from the database according to a spatial layout.

11. The computer system of claim 10, wherein the presentation module is operative to interactively change a view of the spatial layout in response to user input.

12. The computer system of claim 11, wherein the presentation module is responsive to data from the database of varying number of entities to vary the spatial layout according to a number of entities presented in the layout.

13. A computer system for generating morph videos from a time-ordered sequence of digital images, comprising:
querying a database for a pair of images,
performing automatic face feature detection on each image in the pair of images to produce a first set of landmark points and a second set of landmark points;
defining correspondences between points between the first and second sets of landmark points;
processing each image in the pair of images to produce a first set of additional points and a second set of additional points along an edge of a background in the images; and
processing the pair of images using the correspondences and the additional points according to a morphing process to generate a morph video.

14. The computer system of claim 13 wherein querying the database comprises accessing the database to retrieve a first image for an individual taken at a first point in time and a second image of the individual taken at a second, later, point in time.

15. The computer system of claim 13, wherein the additional points are found by analyzing images to find the edges that lie along rays cast to the edges of the image from center points in the image.

16. The computer system of claim 13 wherein the additional points are found using transparency information associated with the image.

17. The computer system of claim 13, wherein the additional points are found using attributes of the red, green and blue channels of an image.

18. The computer system of claim 13, wherein the morph is rendered to a video stream in a non-real-time process.

19. The computer system of claim 13, wherein the correspondences and additional points are computed and the morph is processed in a real-time rendering system.
